(19) United States
(12) Patent Application Publication
(10) Pub. No.: US 2013/0015362 A1
(43) Pub. Date: Jan. 17, 2013

(54) FLUID PURIFICATION AND SENSOR SYSTEM

(71) Applicants: Stewart Edward HOOPER, Oxford (GB); Tim Michael SMEETON, Oxford (GB); Allan EVANS, Oxford (GB)

(72) Inventors: Stewart Edward HOOPER, Oxford (GB); Tim Michael SMEETON, Oxford (GB); Allan EVANS, Oxford (GB)

(73) Assignee: SHARP KABUSHIKI KAISHA, Osaka (JP)

(21) Appl. No.: 13/180,971

(22) Filed: Jul. 12, 2011

(51) Int. Cl. G01J 1/42; G01J 1/58

(52) U.S. Cl. 250/372; 250/208.2; 250/458.1; 250/395

(57) ABSTRACT

A system and method are disclosed for the simultaneous optical disinfection and detection of biological particles in a flowing fluid, such as air or water, medium. A light source for irradiating the flowing medium is a dual wavelength laser element simultaneously emitting a visible laser beam and an ultraviolet laser beam. In particular, a laser diode may generate a first visible laser light beam, and a second ultraviolet laser light beam may be generated by passing the first laser light beam through a frequency doubling crystal. Optical detectors measure scattering, fluorescence and/or transmission of the laser light beams from the air or water medium to determine the presence of biological particles in real-time.

### TECHNICAL FIELD

The present invention relates to an apparatus for the treatment of a fluid, such as for example air or water, and the detection of fluid contamination. In particular, the present invention relates to the use of a dual wavelength emitting laser in an apparatus for the treatment of air or water and the detection of airborne or waterborne contamination. The invention may be applied to a product which purifies air and confirms whether or not the air is safe to breathe. The invention also may be applied to a product which purifies drinking water and confirms whether or not the water is safe to drink.

### BACKGROUND ART

There is an ever increasing need for clean and safe air to breathe and water to drink, particularly in heavily populated countries or regions throughout the world. A major, high-volume, application for compact solid-state deep ultraviolet (UV-C) light sources is for chemical-free sterilisation of air or water. UV-C light causes permanent physical damage to DNA which prevents bacteria, viruses and fungi from replicating. This means that UV-C treatment can be used to disinfect air or water at points-of-use for safe breathing or drinking. UV-C light is particularly effective at destroying the e-coli bacteria.

Compact solid-state UV-C light sources also have application in bio- and chemical-sensing because biological and chemical compounds strongly absorb UV-C light. Proteins and other organic chemicals can be identified from their fluorescence spectra. A fluorescence measurement requires illumination with light at a short wavelength at which the compounds are strongly absorbing, and detection of the resulting fluorescence at longer wavelengths. Wavelengths near about 280 nm are suitable, but shorter wavelengths of about 220 nm are preferred owing to the stronger absorbance at this wavelength.

Point-of-use products for the UV-C treatment of air and water are already available, and these products use mercury lamps as the UV light source. However, mercury lamps contain toxic material, tend to have short operating lifetimes and long warm-up times. An alternative UV light source currently under development is the UV semiconductor light emitting diode (LED). The current drawbacks to using UV LEDs are again lifetime issues, their poor performance below a wavelength of 260 nm and their inability to provide a collimated beam or tightly focused light spot. UV-C lasers, on the other hand, potentially provide a monochromatic, coherent, collimated and easily focusable beam which can be rapidly modulated for fluorescence measurements. UV-C lasers also emit at wavelengths down to 205 nm.

A UV-C laser can be realised by frequency doubling a blue-violet wavelength laser diode. Nishimura, JJAP 42, 5079 (2003) reported on making a UV-C laser in this way. An advantage of using a UV-C laser made by frequency doubling is that the device can be made to emit both the UV-C laser light (205-230 nm) and the blue-violet laser light (410-460 nm). The two wavelengths of light are particularly useful in a sensor system for distinguishing between micro-organisms of different species and size.

Several systems for the detection and treatment of micro-organisms in air using UV lasers are disclosed in the following:

Yoshinaga et al., U.S. Pat. No. 5,123,731, issued on Jun. 13, 1992, discloses a particle measuring device which uses two laser wavelengths through frequency doubling a first laser beam. The use of laser wavelengths down to 200 nm are specified; however, no mention of air treatment is made in this patent, and the system does not provide treatment of the particles.

Silcott et al., U.S. Pat. No. 7,106,442, issued on Sep. 12, 2006, discloses another particle measuring device which uses multiple laser beams of different wavelengths, including frequency doubled laser beams. Treatment of the particles is not mentioned in this patent.

Wilson et al., U.S. Pat. No. 7,242,009, issued on Jul. 10, 2007, discloses a method of using multiple wavelength laser induced fluorescence to distinguish between threat and background airborne particles. Again, no method of treating the threat particles is disclosed.

Berry et al., WO2004110504A2, published on Dec. 23, 2004, is an air sterilising system which uses a UV laser. The use of multiple laser wavelengths is specified, but only in a discrete narrow range. The system does not provide sensing.

Zamir, WO2005011753A1, published on Feb. 10, 2005, discloses another system for sterilising liquids and gases using a UV laser. Only UV light is used, and there is no sensing of micro-organisms.

Several systems for the treatment and detection of micro-organisms in water using UV lasers are disclosed in the following:

Baca et al., U.S. Pat. No. 6,919,019B2, issued on Jul. 19, 2005, discloses a laser water detection and treatment system for the military. However, this system has micro-organism sensing which is separate from the water treatment zone, and a laser is not used for the sensing of micro-organisms. Both of these issues will increase the size and cost of such a system.

Goudy, Jr., U.S. Pat. No. 4,816,145, issued on Mar. 28, 1989, discloses a system for the laser disinfection of fluids. The device disinfects water using a UV (gas) laser and sensors to adjust the laser power to compensate for scattering. Only one laser wavelength is used (UV), and the detectors do not distinguish between scattering, absorption and fluorescence. Again, the size and cost of such a system are likely to be problematic. Also, the sensitivity and range of the detector will be limited in this device.

Baca, U.S. Pat. No. 6,740,244B2, issued on May 25, 2004, discloses another laser water treatment system that disinfects water near point-of-use using a UV laser. Only a UV laser is used, and there is no sensing in this device.

Safta, U.S. Pat. No. 6,767,458B2, issued on Jul. 27, 2004, discloses another water purification system using only a UV laser. However, it does not have sensing.

Killinger et al., U.S. Pat. No. 7,812,946, issued on Oct. 12, 2010, discloses a water monitoring apparatus that includes a UV LED source to excite fluorescence from dissolved organic compounds. The use of a UV laser is mentioned but only as a performance comparison to the UV LED.

### SUMMARY OF INVENTION

Aspects of the invention include a system for the disinfection of a flowing fluid, such as for example air or water, using ultraviolet laser light, and the determination of fluid (air or water) purity from detecting and comparing fluorescence, scattering and absorption of visible and ultraviolet laser light in the fluid (air or water) flow.

Exemplary embodiments of the invention include a laser light source simultaneously generating both visible and ultraviolet laser beams. Both laser beams are incident on a narrow stream of flowing fluid, such as for example air or water, containing micro-organism particulates. The micro-organisms mostly absorb the UV laser light, causing them to both fluoresce and be destroyed, and mostly transmit and scatter the visible blue-violet laser light. By detecting and comparing the fluorescence, absorption and scattering of the different laser beams, the air or water purity can be determined.

Advantages of the invention include:
a) The high efficacy of the UV-C laser wavelength for rapidly destroying bacteria, strongly exciting bacteria fluorescence and being strongly absorbed in contaminated water.
b) The use of highly collimated and tightly focused laser beams for fast and effective water treatment and achieving high sensing signals from waterborne micro-organisms.
c) Both the visible and UV laser beams are generated by the same light source. Therefore, component size, cost and power consumption is low.
d) The two wavelengths of light are particularly useful in a sensor system for distinguishing between micro-organisms of different species and size.

Other exemplary embodiments of the present invention include a system with an apparatus having a conduit for directing a flow path of a fluid, such as air or water, containing biological particles at a constant velocity along a straight path, and a laser light source simultaneously emitting both an ultraviolet and a visible laser beam that is directed to be incident on the flow path of the air or water. The visible laser beam may be generated by a laser diode, and the ultraviolet laser beam may be generated by frequency doubling the visible laser beam using a non-linear optical crystal. The ultraviolet laser beam excites the biological particles to fluoresce and damage their DNA structure at the same time. The system may further include a sensor for measuring the scattered laser light from the biological particles in the directed flow path, a sensor for measuring the fluorescence from the biological particles in the flow path, and a sensor for measuring the transmission of laser light through the flow path to determine absorption of the laser light by the water or air. The system further may include a controller configured to determine whether contaminants are present in the fluid based upon the detections of the sensors.

Accordingly, an aspect of the invention is a system for purifying a fluid or determining fluid purity. An embodiment of the system includes a light source for generating a first laser light beam incident upon a flow path of the fluid, and a frequency doubler for doubling the frequency of at least a portion of the first laser light beam to generate a second laser light beam incident upon the flow path of the fluid, wherein the second laser light beam has a wavelength suitable for absorption by contaminants in the fluid. A plurality of light detectors detect at least one of the first laser light beam or the second laser light beam after the light beams exit the flow path. A controller is configured to determine whether contaminants are present in the fluid based upon the detections of the plurality of light detectors.

In another exemplary embodiment of the system, the first laser light beam is a visible laser light beam and the second laser light beam is an ultraviolet laser light beam.

In another exemplary embodiment of the system, the wavelength of the ultraviolet laser light beam is exactly half that of the visible laser light beam.

In another exemplary embodiment of the system, the ultraviolet laser beam has a wavelength of less than 270 nm.

In another exemplary embodiment of the system, the ultraviolet laser beam has a wavelength of less than 230 nm.

In another exemplary embodiment of the system, the ultraviolet laser beam has a wavelength of less than 210 nm.

In another exemplary embodiment of the system, the visible laser beam has a wavelength of less than 540 nm.

In another exemplary embodiment of the system, the visible laser beam has a wavelength of less than 460 nm.

In another exemplary embodiment of the system, the visible laser beam has a wavelength of less than 420 nm.

In another exemplary embodiment of the system, at least one of the light detectors is a scattering light detector that measures light scattered from the flow path.

In another exemplary embodiment of the system, at least one of the light detectors is a transmitted light detector that measures light transmitted through the flow path.

In another exemplary embodiment of the system, at least one of the light detectors is a fluorescence light detector that measures fluorescence from the flow path.

In another exemplary embodiment of the system, the first laser beam is a pulsating laser beam.

In another exemplary embodiment of the system, the system further includes a conduit defining the flow path of the fluid.

In another exemplary embodiment of the system, the conduit includes a plurality of optical window regions that are transparent to wavelengths of light corresponding to wavelengths of light of the first and second laser light beams.

In another exemplary embodiment of the system, the first and second laser light beams intersect the flow path at different points.

In another exemplary embodiment of the system, the fluid is contained in a vessel as a static volume flow path.

In another exemplary embodiment of the system, the light source includes a semiconductor laser diode for generating the first laser light beam.

In another exemplary embodiment of the system, the frequency doubler is a non-linear optical crystal.

In another exemplary embodiment of the system, the frequency doubler is a beta-Barium Borate non-linear optical crystal.

Another aspect of the invention is a method for purifying a fluid or determining fluid purity. An exemplary embodiment of the method may include the steps of generating a first laser light beam incident upon a flow path of the fluid; doubling the frequency of at least a portion of the first laser light beam to generate a second laser light beam incident upon the flow path of the fluid wherein the second laser light beam has a wavelength suitable for absorption by contaminants in the fluid; detecting at least one of the first laser light beam or the second laser light beam after the light beams exit the flow path; and determining whether contaminants are present in the fluid based upon the light detections.

In another exemplary embodiment of the method, the first laser light beam is a visible laser light beam and the second laser light beam is an ultraviolet laser light beam having half the wavelength of the first laser light beam.

In another exemplary embodiment of the method, the first and second laser light beams intersect the flow path at different points.

In another exemplary embodiment of the method, detecting at least one of the first laser light beam or the second laser light beam comprises at least one of detecting light that is scattered from the flow path, detecting light that is transmitted through flow path, or detecting light fluorescence from the flow path.

In another exemplary embodiment of the method, the fluid is at least one of air or water.

To the accomplishment of the foregoing and related ends, the invention, then, comprises the features hereinafter fully described and particularly pointed out in the claims. The following description and the annexed drawings set forth in detail certain illustrative embodiments of the invention. These embodiments are indicative, however, of but a few of the various ways in which the principles of the invention may be employed. Other objects, advantages and novel features of the invention will become apparent from the following detailed description of the invention when considered in conjunction with the drawings.

### BRIEF DESCRIPTION OF DRAWINGS

FIG. 1 is a schematic diagram depicting an air or water purification and sensor system according to an exemplary embodiment of the invention.

FIG. 2 is a top plan view of the component configuration of a UV laser made by frequency doubling a blue-violet laser light beam from a laser diode.

FIG. 3 is a graphical representation of the actual light output produced by a dual wavelength laser where the UV laser beam (b) is made by frequency doubling a blue-violet laser diode beam (a).

FIG. 4 is a schematic diagram depicting a water purification and sensor system according to an exemplary embodiment of the invention.

FIG. 5 is a schematic diagram depicting an air purification and sensor system according to another exemplary embodiment of the invention.

FIG. 6 is a schematic diagram depicting a static purification and sensor system according to another exemplary embodiment of the invention.

### DESCRIPTION OF REFERENCE NUMERALS

1 Dual wavelength laser source
1a Laser diode
1b Frequency doubling (FD) crystal
2 Flow conduit containing air or water stream
2a Flow conduit containing water stream
2b Flow conduit containing air stream
3 Light detectors
3a Light detector to measure laser light scattered from the flow stream
3b Light detector to measure laser induced fluorescence from the flow stream
3c Light detector to measure laser light transmitted through the flow stream
4 Treatment vessel containing volume of air or water
5 Conduit optical window region
6 Vessel optical window region
7 Controller

### DETAILED DESCRIPTION OF INVENTION

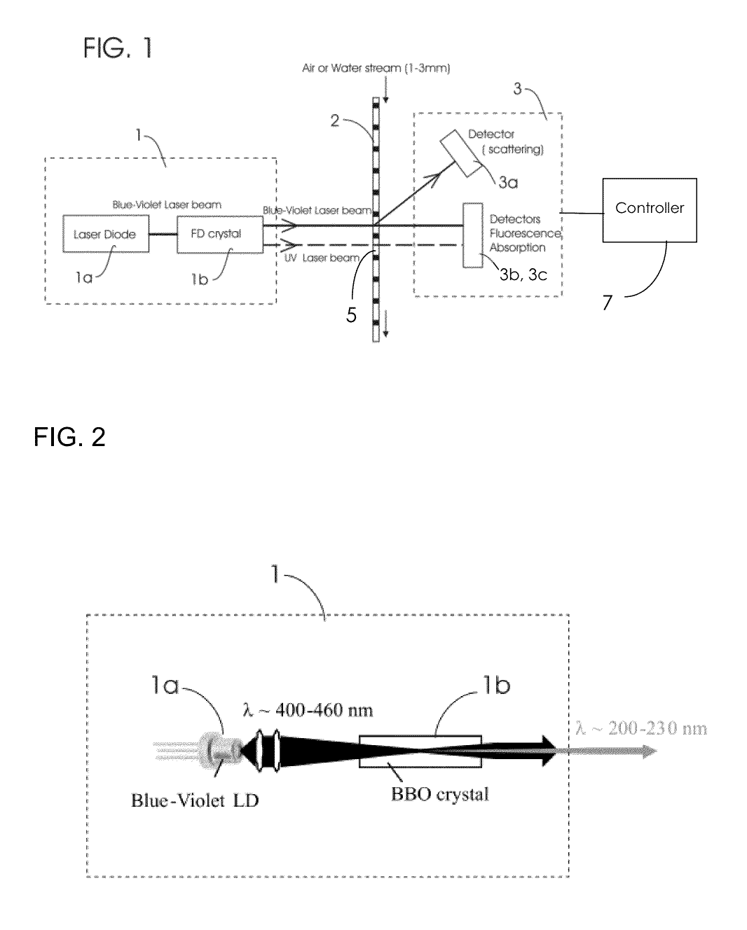

Referring to FIGS. 1 and 2, the present invention uses a dual wavelength laser 1 made by frequency doubling a first visible laser light beam from a semiconductor laser diode 1a to generate a second ultraviolet laser light beam. The frequency doubling is achieved using a frequency doubler in the form of, for example, a non-linear optical frequency doubling (FD) crystal 1b. FIG. 2 illustrates a top plan view of a dual wavelength laser component 1 made by frequency doubling a blue-violet laser beam.

The first blue-violet laser light beam may be generated by a blue-violet laser diode 1a and may have a wavelength in the range 410 to 460 nm. Green laser diodes with wavelengths as long as 540 nm are also suitable. The monochromatic blue-violet laser beam is shaped and focused into a frequency doubler, such as a non-linear optical FD crystal 1b that may be made of beta-Barium Borate (BaB₂O₄ or BBO) with a pre-determined crystal cut, orientation and geometric shape. The BBO FD crystal frequency doubles the input laser beam to produce the second ultraviolet output laser light beam with double the frequency (or half the wavelength). For example, an input laser beam of 460 nm will produce an output laser beam of 230 nm. As depicted in FIG. 1, for example, only a percentage of the input beam is frequency doubled, and the remainder passes straight through. For example, one component of the outputted beam may be the first blue-violet laser light beam, and another component of the outputted beam may be the second ultraviolet (UV) laser light beam with double the frequency (half the wavelength) of the first blue-violet laser beam. Therefore, the output from the BBO FD crystal contains a pair of beams with two different laser wavelengths (the input and the frequency doubled components). The second UV laser light beam typically would be of wavelength suitable for purifying the air or water, in that biological contaminants may absorb light from the UV laser light beam and be destroyed.

In an exemplary embodiment, the BBO FD crystal may be placed inside a re-circulating optical cavity which allows multiple passes of the incident blue-violet laser beam through the BBO FD crystal, thereby increasing the total amount of blue-violet light converted into UV light. In addition, one may increase the total amount of blue-violet light converted into UV light by mechanically shaping the BBO FD crystal into a ridge waveguide structure with dimensions of several micrometers in directions orthogonal to the blue-violet laser beam and several millimeters in the same direction as the blue violet laser beam.

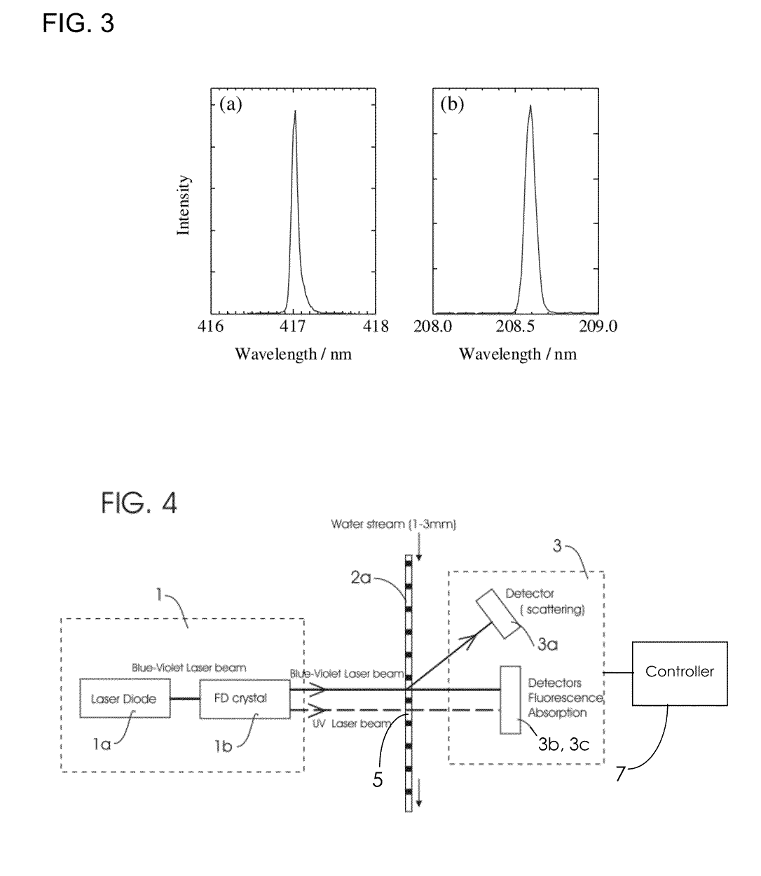

FIG. 3 shows the optical spectra from a dual wavelength laser 1 made by frequency doubling a single beam pass of a blue-violet laser diode 1a through a BBO FD crystal 1b. The blue-violet laser diode can be modulated or pulsed at very high speed; therefore, the UV laser beam can also be modulated at the same speed. The UV laser beam (b) is essentially half the wavelength of the blue-violet laser beam (a).

Examples of the operation of the present invention are described below. Although the invention is described principally in connection with the purification and detection of contaminants in air or water, it will be appreciated that the invention is not limited in such regard. Rather, the invention may be utilized in connection with any suitable fluid (the term fluid being understood to include both liquids and gases).

### Example 1

An exemplary preferred embodiment of the present invention is now described with reference to FIG. 4. The system illustrated in FIG. 4 includes a conduit 2a that provides a flow path through which a steady flow of water passes. A conduit diameter in the range 1 to 10 mm is preferred, and 3 mm is most preferred. A water flow in the range 0.1 to 3 litres per minute is preferred, and 1 litre per minute is most preferred. The conduit contains an optical window region 5 that is transparent to light in the wavelength range between about ultraviolet and infrared, and thus is transparent to wavelengths of light of the first blue-violet laser light beam and the second ultraviolet laser light beam. The optical window region 5, for example, may be crystal quartz.

The pair of laser beams provided by the dual wavelength laser component 1 are split and then directed onto the water flow via the optical window region. The UV laser beam typically will be absorbed by any biological particles or micro-organisms in the water causing them to fluoresce. The DNA structure of the biological particles typically will also be physically damaged or destroyed by the UV light. Some of the UV laser beam will also scatter off the particles or pass through the water (depending on its purity). Most of the blue-violet laser beam typically will either pass through the water or scatter off the particles. However, some particle fluorescence may also be induced by the blue-violet laser beam.

A plurality of light detectors 3 are positioned to receive light that exits the flow path from the optical window region 5 of the water conduit. For example, the light detectors 3 may include detectors to measure the light scattering (detector 3a), fluorescing (detector 3b) or light being transmitted (detector 3c) by any biological particles in the water (which in turn may be used to determine absorption). CCD sensors are preferred detectors due to their compact size. Optical filters may also be used to distinguish between signals. Pulsing the laser beams may be employed as the input light signals. The type, size, and number of biological particles in the water stream may be determined by detecting and comparing the corresponding scattering, fluorescence and transmission signals.

The conduit 2a may contain several optical window regions 5 for light to exit the water flow that are not adjacent to the entry window. This provides a means for the UV laser beam to experience multiple reflections inside the conduit before exiting, thereby increasing its germicidal effectiveness in destroying any micro-organisms.

A controller 7 receives and processes outputs from the plurality of light detectors 3. The controller 7 is configured to determine whether contaminants are present in the water based upon the detections of the plurality of light detectors 3. More specifically, the controller 7 may compare the outputs of the light detectors 3 against a library of stored reference signals produced by known contaminants. In this way, contaminant species can be identified and quantified. Optical filters may be employed in conjunction with the light detectors 3 so as to improve signal to noise ratio. The controller 7 may be provided in the form of a control circuit or processing device that may execute program code stored on a machine-readable medium. Such controller functionality could also be carried out via dedicated hardware, firmware, software, or combinations thereof, without departing from the scope of the invention.

### Example 2

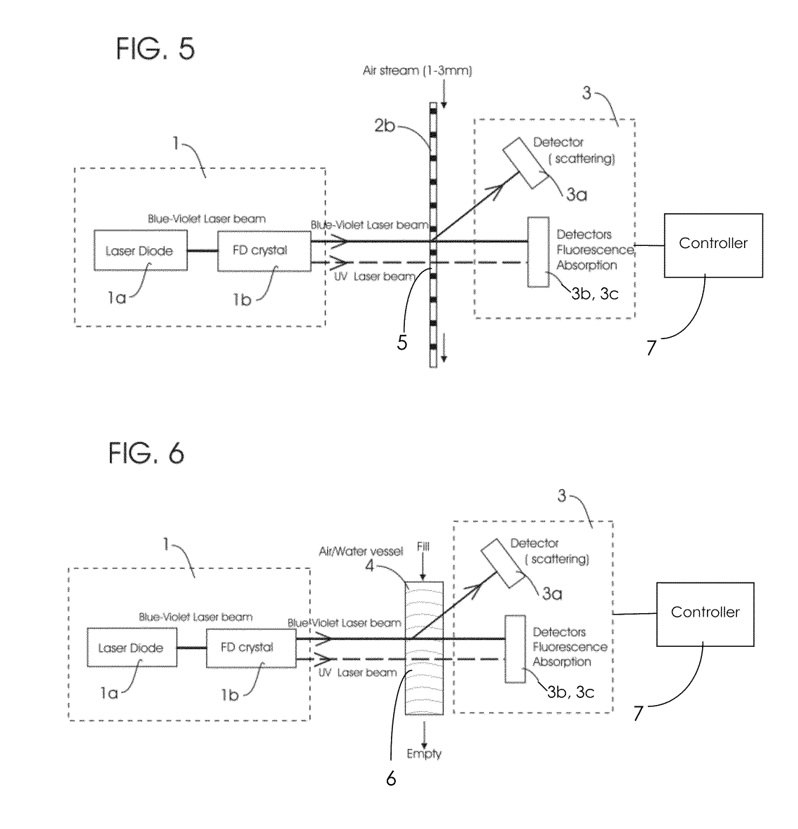

Another exemplary preferred embodiment of the disclosed system is illustrated in FIG. 5. The embodiment of FIG. 5 includes conduit 2b that provides a flow path through which a steady flow of air passes. A conduit diameter in the range 1 to 10 mm is preferred, and 3 mm is most preferred. An air flow in the range 0.1 to 3 litres per minute is preferred, and 1 litre per minute is most preferred. The conduit contains an optical window region 5 that is transparent to light in the wavelength range between ultraviolet and infrared, and thus is transparent to wavelengths of light of the first blue-violet laser light beam and the second ultraviolet laser light beam. The optical window region 5, for example, may be crystal quartz.

The pair of laser beams provided by the dual wavelength laser component 1 are split and then directed onto the air flow via the optical window region. The UV laser beam typically will be absorbed by any biological particles or micro-organisms in the air causing them to fluoresce. The DNA structure of the biological particles typically will also be physically damaged or destroyed by the UV light. Some of the UV laser beam will also scatter off the particles or pass through the air (depending on its purity). Most of the blue-violet laser beam typically will either pass through the air or scatter off the particles. However, some particle fluorescence may also be induced by the blue-violet laser beam.

A plurality of light detectors 3 are positioned to receive light that exits the flow path from the optical window region of the air conduit. For example, the light detectors 3 may include detectors to measure the light scattering (detector 3a), fluorescing (detector 3b) or being transmitted (detector 3c) by any biological particles in the air (which in turn may be used to determine absorption). CCD sensors are preferred detectors due to their compact size. Optical filters may also be used to distinguish between signals. Pulsing laser beams may be employed as the light input signal. The type, size and number of biological particles in the air stream may be determined by detecting and comparing the corresponding scattering, fluorescence and transmission signals.

The conduit 2b may contain several optical window regions 5 for light to exit the air flow that are not adjacent to the entry window. This provides a means for the UV laser beam to experience multiple reflections inside the conduit before exiting, thereby increasing its germicidal effectiveness in destroying any micro-organisms.

As in the previous example, a controller 7 receives and processes outputs from the plurality of light detectors 3. The controller 7 is configured to determine whether contaminants are present in the air based upon the detections of the plurality of light detectors 3.

### Example 3

Another exemplary preferred embodiment of the disclosed system is illustrated in FIG. 6. The embodiment of FIG. 6 includes a vessel 4 which is periodically filled and emptied with a volume of air or water, and in which the volume of air or water is held for germicidal treatment and detection. A vessel volume in the range 10 to 1000 mm³ is preferred, and 125 mm³ is most preferred. The vessel contains optical window regions 6 that are transparent to light in the wavelength range between ultraviolet and infrared, and thus is transparent to wavelengths of light of the first blue-violet laser light beam and the second ultraviolet laser light beam. The optical window region 6, for example, may be crystal quartz.

The pair of laser beams provided by the dual wavelength laser component 1 are split and then directed onto the air or water volume via the optical window region. The UV laser beam typically will be absorbed by any biological particles or micro-organisms in the air/water causing them to fluoresce. The DNA structure of the biological particles typically will also be physically damaged or destroyed by the UV light. Some of the UV laser beam will also scatter off the particles or pass through the air/water (depending on its purity). Most of the blue-violet laser beam typically will either pass through the air/water or scatter off the particles. However, some particle fluorescence may also be induced by the blue-violet laser beam.

A plurality of light detectors 3 are positioned to receive light that exits the vessel from the optical window region 6 of the air/water vessel. For example, the light detectors 3 may include detectors to measure the light scattering (detector 3a), fluorescing (detector 3b) or being transmitted (detector 3c) by any biological particles in the air or water (which in turn may be used to determine absorption). CCD sensors are preferred detectors due to their compact size. Optical filters may also be used to distinguish between signals. Pulsing laser beams may be employed as the input light signal. The type, size and number of biological particles in the air/water volume may be determined by detecting and comparing the corresponding scattering, fluorescence and transmission signals.

The vessel 4 may contain several optical window regions 6 for light to exit the air/water that are not adjacent to the entry window. This provides a means for the UV laser beam to experience multiple reflections inside the vessel before exiting, thereby increasing its germicidal effectiveness in destroying any micro-organisms.

As in the previous examples, a controller 7 receives and processes outputs from the plurality of light detectors 3. The controller 7 is configured to determine whether contaminants are present in the air or water based upon the detections of the plurality of light detectors 3.

Once germicidal treatment of the air/water volume is completed, the vessel 4 may be emptied into another vessel ready for safe use, and the first vessel 4 may then be refilled with a new volume of air/water for treatment and sensing.

Although the invention has been shown and described with respect to a certain embodiment or embodiments, equivalent alterations and modifications may occur to others skilled in the art upon the reading and understanding of this specification and the annexed drawings. In particular regard to the various functions performed by the above described elements (components, assemblies, devices, compositions, etc.), the terms (including a reference to a “means”) used to describe such elements are intended to correspond, unless otherwise indicated, to any element which performs the specified function of the described element (i.e., that is functionally equivalent), even though not structurally equivalent to the disclosed structure which performs the function in the herein exemplary embodiment or embodiments of the invention. In addition, while a particular feature of the invention may have been described above with respect to only one or more of several embodiments, such feature may be combined with one or more other features of the other embodiments, as may be desired and advantageous for any given or particular application.

1. A system for purifying a fluid or determining fluid purity comprising:
a light source for generating a first laser light beam incident upon a flow path of the fluid;
a frequency doubler for doubling the frequency of at least a portion of the first laser light beam to generate a second laser light beam incident upon the flow path of the fluid, wherein the second laser light beam has a wavelength suitable for absorption by contaminants in the fluid;
a plurality of light detectors that detect at least one of the first laser light beam or the second laser light beam after the light beams exit the flow path; and
a controller configured to determine whether contaminants are present in the fluid based upon the detections of the plurality of light detectors.

2. The system of claim 1, wherein the first laser light beam is a visible laser light beam and the second laser light beam is an ultraviolet laser light beam.

3. The system of claim 2, wherein the wavelength of the ultraviolet laser light beam is exactly half that of the visible laser light beam.

4. The system of claim 2, wherein the ultraviolet laser beam has a wavelength of less than 270 nm.

5. The system of claim 4, wherein the ultraviolet laser beam has a wavelength of less than 230 nm.

6. The system of claim 5, wherein the ultraviolet laser beam has a wavelength of less than 210 nm.

7. The system of claim 2, wherein the visible laser beam has a wavelength of less than 540 nm.

8. The system of claim 7, wherein the visible laser beam has a wavelength of less than 460 nm.

9. The system of claim 8, wherein the visible laser beam has a wavelength of less than 420 nm.

10. The system of claim 1, wherein at least one of the light detectors is a scattering light detector that measures light scattered from the flow path.

11. The system of claim 1, wherein at least one of the light detectors is a transmitted light detector that measures light transmitted through the flow path.

12. The system of claim 1, wherein at least one of the light detectors is a fluorescence light detector that measures fluorescence from the flow path.

13. The system of claim 1, wherein the first laser beam is a pulsating laser beam.

14. The system of claim 1, further comprising a conduit defining the flow path of the fluid.

15. The system of claim 14, wherein the conduit includes a plurality of optical window regions that are transparent to wavelengths of light corresponding to wavelengths of light of the first and second laser light beams.

16. The system of claim 15, wherein the first and second laser light beams intersect the flow path at different points.

17. The system of claim 1, wherein the fluid is contained in a vessel as a static volume flow path.

18. The system of claim 1, wherein the light source includes a semiconductor laser diode for generating the first laser light beam.

19. The system of claim 1, wherein the frequency doubler is a non-linear optical crystal.

20. The system of claim 19, wherein the frequency doubler is a beta-Barium Borate non-linear optical crystal.

21. A method for purifying a fluid or determining fluid purity comprising the steps of:
generating a first laser light beam incident upon a flow path of the fluid;
doubling the frequency of at least a portion of the first laser light beam to generate a second laser light beam incident upon the flow path of the fluid wherein the second laser light beam has a wavelength suitable for absorption by contaminants in the fluid;
detecting at least one of the first laser light beam or the second laser light beam after the light beams exit the flow path; and
determining whether contaminants are present in the fluid based upon the light detections.

22. The method of claim 21, wherein the first laser light beam is a visible laser light beam and the second laser light beam is an ultraviolet laser light beam having half the wavelength of the first laser light beam.

23. The method of claim 21, wherein the first and second laser light beams intersect the flow path at different points.

24. The method of claim 21, wherein detecting at least one of the first laser light beam or the second laser light beam comprises at least one of detecting light that is scattered from the flow path, detecting light that is transmitted through flow path, or detecting light fluorescence from the flow path.

25. The method of claim 21, wherein the fluid is at least one of air or water.
